(19) United States
(12) Patent Application Publication
(10) Pub. No.: US 2008/0218491 A1
(43) Pub. Date: Sep. 11, 2008

(54) Input Interface and Input Method

(75) Inventor: Shui-Ming Wu, Shanghai City (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INVENTEC APPLIANCES CORP., Taipei Hsien (TW)

(21) Appl. No.: 12/044,575

(22) Filed: Mar. 7, 2008

(30) Foreign Application Priority Data
Mar. 9, 2007 (TW) 96108296

(51) Int. Cl. G06F 3/041

(52) U.S. Cl. 345/173

(57) ABSTRACT

An input interface for an electronic apparatus includes a touchpad, a touch sensor, a touch command generator, a push sensor and a push command generator. The touchpad has a plurality of keys arranged thereon. The touch sensor senses whether an object touches one of the keys. The touch command generator generates a touch command to the electronic apparatus when the object slides across adjacent two of the keys. The push sensor senses whether one of the keys is pushed. The push command generator generates a push command to the electronic apparatus when one of the keys is pushed. Furthermore, an input method for the electronic apparatus is also disclosed hereinafter.

### RELATED APPLICATIONS

This application claims priority to Taiwan Application Serial Number 96108296, filed Mar. 9, 2007, which is herein incorporated by reference.

### BACKGROUND

1. Field of Invention

The present invention relates to an electronic apparatus. More particularly, the present invention relates to an input interface and an input method for the electronic apparatus.

2. Description of Related Art

The cell phone is so popular today that cell phone manufacturers make great effort to provide more functions on the cell phone in order to satisfy different user needs. For example, some cell phones have incorporated many personal digital assistant applications, such as Address Book, Schedule, Note, To-Do list, therein.

However, almost all of those cell phones employ a touchscreen as a user interface without any hardware keyboard because consumers prefer small size cell phones. That is, a user have to hold a stylus in one hand and a cell phone in the other hand during the input operation of the touchscreen because the software keyboard displayed on the touchscreen is too small for fingers. Therefore, this kind of design (i.e. software keyboard) is inconvenient to input letters or numerals, especially for outdoor users.

### SUMMARY

According to one embodiment of the present invention, an input interface for an electronic apparatus includes a touchpad, a touch sensor, a touch command generator, a push sensor and a push command generator. The touchpad has a plurality of keys arranged thereon. The touch sensor senses whether an object touches one of the keys. The touch command generator generates a touch command to the electronic apparatus when the object slides across adjacent two of the keys. The push sensor senses whether one of the keys is pushed. The push command generator generates a push command to the electronic apparatus when one of the keys is pushed.

According to another embodiment of the present invention, an input method for an electronic apparatus having a plurality of keys includes the steps of:

(a) sensing whether an object touches one of the keys;

(b) generating a touch command to the electronic apparatus when the object slides across adjacent two of the keys;

(c) sensing whether one of the keys is pushed; and

(d) generating a push command to the electronic apparatus when one of the keys is pushed.

### BRIEF DESCRIPTION OF THE DRAWINGS

The invention can be more fully understood by reading the following detailed description of the embodiment, with reference made to the accompanying drawings as follows:

FIG. 1 is an exploded view of an input interface according to one embodiment of the present invention;

FIG. 2 is a sectional view of the input interface of FIG. 1 taken on line 2-2, showing the input interface, which has been assembled;

FIG. 3 is an exploded view of the touchpad of FIG. 1;

FIG. 4 shows the direction definitions of the keys of FIG. 1 when the operating mode of the electronic apparatus is the navigation mode;

FIG. 5 shows how to use the electronic apparatus when the operating mode of the electronic apparatus is the input mode;

FIG. 6 shows how to input a direction command to the electronic apparatus by sliding; and

FIG. 7 shows how to input a wheeling command to the electronic apparatus by swirling.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

In the following embodiments of the present invention, the term “electronic apparatus” may be considered a personal digital assistant (PDA), an electronic dictionary, a digital camera, a cell phone or another handheld device. The following description will take an electronic apparatus having a screen as an illustrative example.

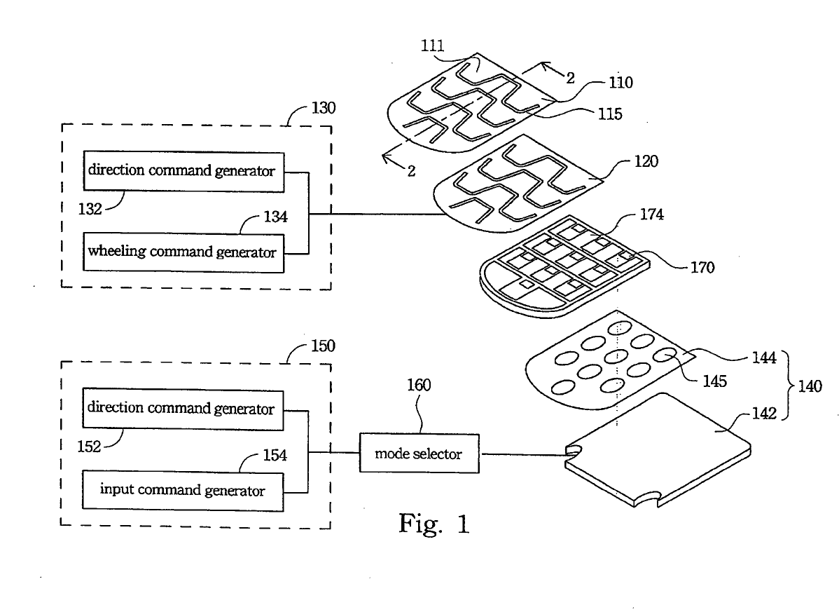

FIG. 1 is an exploded view of an input interface according to one embodiment of the present invention. An input interface for an electronic apparatus includes a touchpad 110, a touch sensor 120, a touch command generator 130, a push sensor 140 and a push command generator 150. The touchpad 110 has a plurality of keys 111 arranged thereon. The touch sensor 120 senses whether an object touches at least one of the keys 111. The touch command generator 130 generates a touch command to the electronic apparatus when the object slides across adjacent two of the keys 111. The push sensor 140 senses whether at least one of the keys 111 is pushed. The push command generator 150 generates a push command to the electronic apparatus when at least one of the keys 111 is pushed.

The input interface of FIG. 1 can provide at least two modes for a user to input commands. That is, the user may just slide his/her finger(s) on the keys of the electronic apparatus to input the touch command without any stylus. On the other hand, the user may also push the keys of the electronic apparatus, not a software keyboard, to input the push command.

Furthermore, the input interface of FIG. 1 may further include a mode selector 160 for selecting a navigation mode or an input mode as the operating mode of the input interface. Therefore, the back end circuits or devices of the electronic apparatus can be actuated according to the operating mode of the input interface when at least one of the keys 111 is pushed.

Specifically, the push command generator 150 may include a direction command generator 152 and an input command generator 154. When the operating mode of the input interface is the navigation mode and one of the keys 111 is pushed, the direction command generator 152 is used to generate a direction command to the electronic apparatus according to a direction from the center of the touchpad 110 to the pushed key.

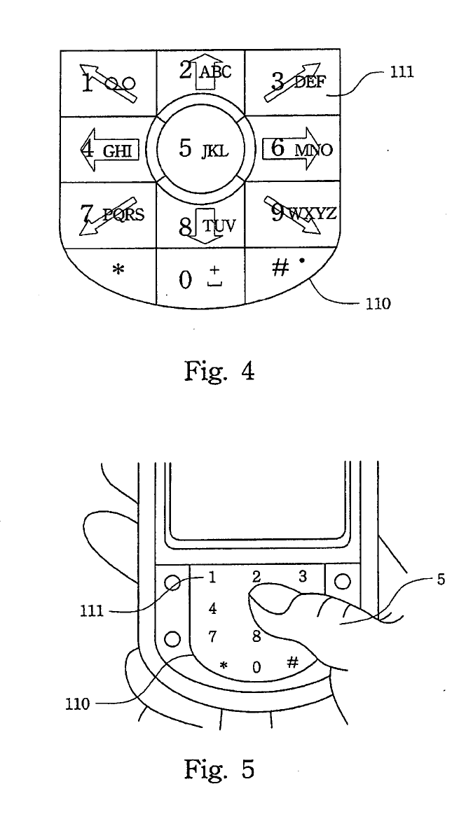

For example, FIGS. 4 and 5 show the keys 111 are arranged on the touchpad 110 in a typical telephone key arrangement, wherein the center of the touchpad 110 is the key “5”. In use, the direction command generator 152 can generate a direction command which makes the cursor in the screen of the electronic apparatus move upwards if the user pushes the key “2”.

On the other hand, when the operating mode of the input interface is the input mode and one of the keys 111 is pushed, the input command generator 154 is used to generate an input command to the electronic apparatus according to a definition of the pushed key. For example, the input command generator 154 can generate an input command which displays number 2 on the screen of the electronic apparatus if the user pushes the key “2”.

The touch command generator 130 of FIG. 1 may include a direction command generator 132. When the object slides across adjacent two of the keys 111, the direction command generator 132 can generate a direction command to the electronic apparatus according to the sliding direction of the object. For example, the direction command generator 132 can generate a direction command which makes the cursor in the screen of the electronic apparatus move upwards if the user slides his/her finger(s) on the touchpad 110 upwards.

The touch command generator 130 of FIG. 1 may further include a wheeling command generator 134. When the object swirls on the touchpad 110, the wheeling command generator 134 can generate a wheeling command to the electronic apparatus according to the swirling direction of the object. For example, the wheeling command generator 134 can generate a wheeling command which makes the cursor in the screen of the electronic apparatus continuously move upwards if the user swirls his/her finger(s) clockwise on the touchpad 110.

The push sensor 140 of FIG. 1 may include a printed circuit board 142 and a dome switch layer 144. The dome switch layer 144 is located on the printed circuit board 142. The dome switch layer 144 has a plurality of dome switches 145 arranged thereon.

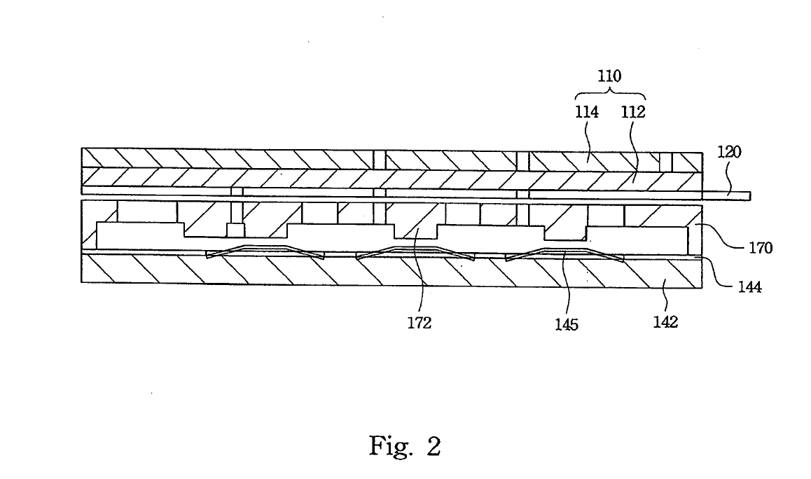

FIG. 2 is a sectional view of the input interface of FIG. 1 taken on line 2-2, showing the input interface, which has been assembled. The input interface of FIGS. 1 and 2 may further include a key frame 170. The key frame 170 is located between the touchpad 110 and the dome switch layer 144. Specifically, the key frame 170 may be located between the touch sensor 120 and the dome switch layer 144. The key frame 170 can absorb the impact caused by the touching operation on the touchpad 110. Therefore, the touching operation on the touchpad will not interfere with the push sensor 140.

The key frame 170 of FIG. 2 may have a plurality of touch points 172 located thereon. The touch points 172 are opposite the dome switch layer 144 for pressing at least one of the dome switches 145 when at least one of the keys 111 is pushed.

As shown in FIG. 1, the key frame 170 may further include a plurality of grooves 174 located thereon. The grooves 174 are opposite the touchpad 110 for fixing the keys 111.

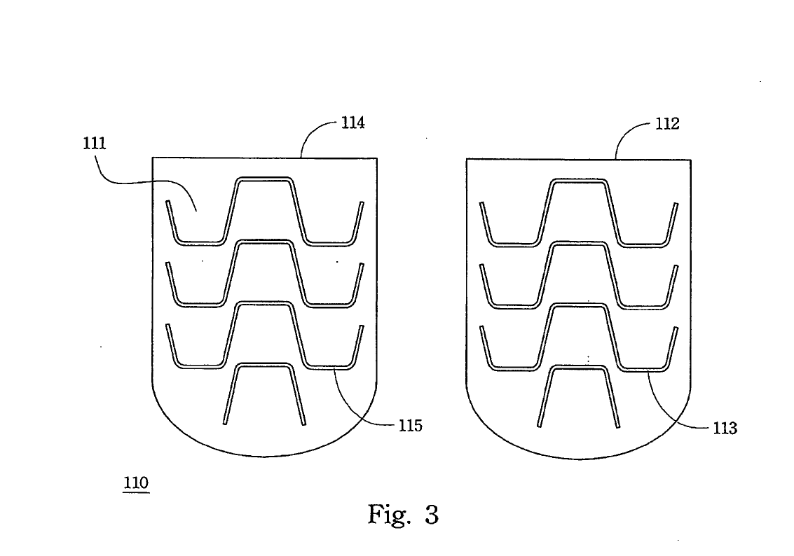

FIG. 3 is an exploded view of the touchpad 110 of FIG. 1. The touchpad 110 includes a positioning film 112 and a surface layer 114. The positioning film 112 has a plurality of positioning grooves 113 located thereon. The surface layer 114 is located on the positioning film 112. The surface layer 114 may have a plurality of frame grooves 115 above the positioning grooves 113 for forming the keys 111. More particularly, the shapes of the positioning grooves 113 and the shapes of the frame grooves 115 are the same, and they are all indented shapes, that is, the positioning grooves 113 and the frame grooves 115 each has alternate recess and protrusion portions (looking from the top).

The positioning film 112 of FIG. 3 may be made of polyurethane thermoplastic elastomer (TPU) to protect the touch sensor from undesirable moisture, dust or static electricity. On the other hand, the surface layer 114 may be made of polyethylene terephthalate (PET).

The touch command generator 130, the push command generator 150 and the mode selector 160 can be either software or hardware. They do not need to be completely software or completely hardware. They can be a combination of both software and hardware.

Moreover, the touch sensor 120 of FIG. 1 may include a capacitor array. The capacitor array can sense the capacitance change to determine whether the object touches at least one of the keys 111. The touch sensor 120 may be, for example, PSoC CY8C21XXX supplied by Cypress. It is easily understood that PSoC CY8C21XXX is only one of the examples. The touch sensor 120 can be another electronic device as well. A manufacturer may select a proper electronic device as the touch sensor according to actual requirements.

According to another embodiment of the present invention, an input method for an electronic apparatus having a plurality of keys includes the steps of:

(a) sensing whether an object touches at least one of the keys;

(b) generating a touch command to the electronic apparatus when the object slides across adjacent two of the keys;

(c) sensing whether at least one of the keys is pushed; and

(d) generating a push command to the electronic apparatus when at least one of the keys is pushed.

The input method may further include the step of selecting a navigation mode or an input mode as the operating mode of the electronic apparatus. Then, the content of the push command may be variable and dependent on the operating mode of the electronic apparatus.

If a user pushes at least one of the keys when the operating mode of the electronic apparatus is the navigation mode, the step (d) can generate a direction command to the electronic apparatus according to a direction definition of the pushed key. FIG. 4 shows the direction definitions of the keys 111 of FIG. 1 when the operating mode of the electronic apparatus is the navigation mode. In use, the user may push at least one of the keys 111, and then the input command is generated to the electronic apparatus according to the direction definition of the pushed key shown in FIG. 4. For example, the cursor in the screen of the electronic apparatus may move upwards if the user pushes the key “2” at this time.

On the other hand, if the user pushes at least one of the keys when the operating mode of the electronic apparatus is the input mode, the step (d) can generate an input command to the electronic apparatus according to an input definition of the pushed key. FIG. 5 shows how to use the electronic apparatus when the operating mode of the electronic apparatus is the input mode. As shown in FIG. 5, the user may push at least one of the keys 111 with his/her finger 5, and then the input command is generated to the electronic apparatus according to the input definition of the pushed key. For example, number 2 may be displayed on the screen of the electronic apparatus if the user pushes the key “2” at this time.

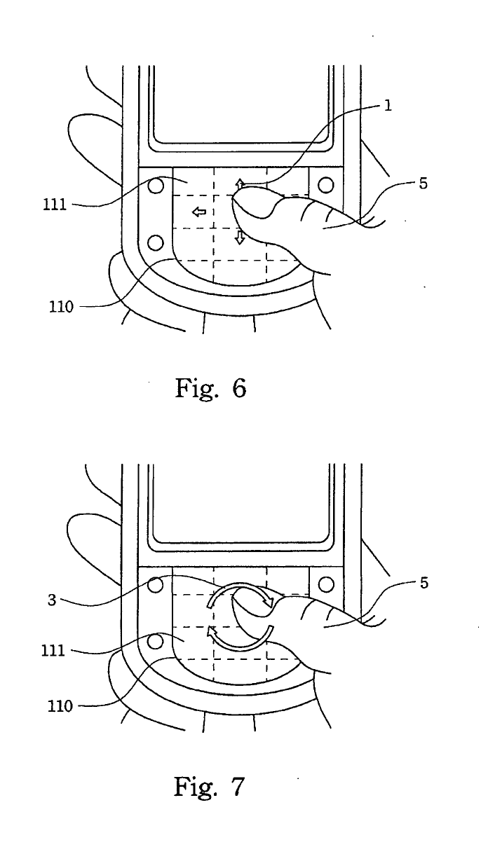

Furthermore, when the object slides across adjacent two of the keys, the step (b) can generate a direction command to the electronic apparatus according to the sliding direction of the object. FIG. 6 shows how to input a direction command to the electronic apparatus by sliding. As shown in FIG. 6, the user may slides his/her finger 5 on the keys 111, i.e. the touchpad 110, and then the direction command is generated to the electronic apparatus according to the sliding direction of the finger 5. For example, the cursor in the screen of the electronic apparatus may move upwards if the user slides his/her finger 5 upwards across adjacent two of the keys 111 (arrow 1).

On the other hand, when the object swirls on the keys, i.e. the touchpad, the step (b) can generate a wheeling command to the electronic apparatus according to the swirling direction of the object. FIG. 7 shows how to input a wheeling command to the electronic apparatus by swirling. As shown in FIG. 7, the user may swirls his/her finger 5 on the keys 111, i.e. the touchpad 110, and then the wheeling command is generated to the electronic apparatus according to the swirling direction of the finger 5. For example, the cursor in the screen of the electronic apparatus may continuously move upwards if the user swirls his/her finger 5 clockwise (arrow 3) on the keys 111, i.e. the touchpad 110.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An input interface for an electronic apparatus, the input interface comprising:
a touchpad comprising a plurality of keys arranged thereon;
a touch sensor for sensing whether an object touches at least one of the keys;
a touch command generator for generating a touch command to the electronic apparatus when the object slides across adjacent two of the keys;
a push sensor for sensing whether at least one of the keys is pushed; and
a push command generator for generating a push command to the electronic apparatus when at least one of the keys is pushed.

2. The input interface of claim 1, further comprising:
a mode selector for selecting a navigation mode or an input mode as the operating mode of the input interface.

3. The input interface of claim 2, wherein the push command generator comprises a direction command generator; and when the operating mode of the input interface is the navigation mode and one of the keys is pushed, the direction command generator is used to generate a direction command to the electronic apparatus according to a direction from the center of the touchpad to the pushed key.

4. The input interface of claim 2, wherein the push command generator comprises an input command generator; and when the operating mode of the input interface is the input mode and one of the keys is pushed, the input command generator is used to generate an input command to the electronic apparatus according to a definition of the pushed key.

5. The input interface of claim 1, wherein the touch command generator comprises a direction command generator for generating a direction command to the electronic apparatus according to the sliding direction of the object when the object slides across adjacent two of the keys.

6. The input interface of claim 1, wherein the touch command generator comprises a wheeling command generator for generating a wheeling command to the electronic apparatus according to the swirling direction of the object when the object swirls on the touchpad.

7. The input interface of claim 1, wherein the push sensor comprises:
a printed circuit board; and
a dome switch layer located on the printed circuit board and comprising a plurality of dome switches arranged thereon.

8. The input interface of claim 7, further comprising:
a key frame located between the touchpad and the dome switch layer.

9. The input interface of claim 8, wherein the key frame comprises:
a plurality of touch points located on the key frame and opposite the dome switch layer for pressing at least one of the dome switches when at least one of the keys is pushed.

10. The input interface of claim 8, wherein the key frame comprises:
a plurality of grooves located on the key frame and opposite the touchpad for fixing the keys.

11. The input interface of claim 1, wherein the touchpad comprises:
a positioning film comprising a plurality of positioning grooves located thereon; and
a surface layer located on the positioning film and comprising a plurality of frame grooves above the positioning grooves for forming the keys.

12. The input interface of claim 11, wherein the positioning film is made of polyurethane thermoplastic elastomer.

13. The input interface of claim 11, wherein the surface layer is made of polyethylene terephthalate.

14. An input method for an electronic apparatus having a plurality of keys, the input method comprising the steps of:
sensing whether an object touches at least one of the keys;
generating a touch command to the electronic apparatus when the object slides across adjacent two of the keys;
sensing whether at least one of the keys is pushed; and
generating a push command to the electronic apparatus when at least one of the keys is pushed.

15. The input method of claim 14, further comprising the step of:
selecting a navigation mode or an input mode as the operating mode of the electronic apparatus.

16. The input method of claim 15, wherein the step of generating the push command to the electronic apparatus comprises:
generating a direction command to the electronic apparatus according to a direction definition of the pushed key when the operating mode of the electronic apparatus is the navigation mode.

17. The input method of claim 15, wherein the step of generating the push command to the electronic apparatus comprises:
generating an input command to the electronic apparatus according to an input definition of the pushed key when the operating mode of the electronic apparatus is the input mode.

18. The input method of claim 14, wherein the step of generating the touch command to the electronic apparatus comprises:
generating a direction command to the electronic apparatus according to the sliding direction of the object when the object slides across adjacent two of the keys.

19. The input method of claim 14, wherein the step of generating the touch command to the electronic apparatus comprises:
generating a wheeling command to the electronic apparatus according to the swirling direction of the object when the object swirls on the keys.
